(19) United States
(12) Patent Application Publication
(10) Pub. No.: US 2017/0337778 A1
(43) Pub. Date: Nov. 23, 2017

(54) GAMING INCORPORATING SOCIAL GROUP FEATURES

(71) Applicants: Gary Stephen SHUSTER, Fresno, CA (US); Brian Mark SHUSTER, Vancouver (CA)

(72) Inventors: Gary Stephen SHUSTER, Fresno, CA (US); Brian Mark SHUSTER, Vancouver (CA)

(21) Appl. No.: 15/673,208

(22) Filed: Aug. 9, 2017

Related U.S. Application Data
(63) Continuation of application No. 13/096,833, filed on Apr. 28, 2011, now abandoned.
(60) Provisional application No. 61/351,202, filed on Jun. 3, 2010.
(60) Provisional application No. 61/329,062, filed on Apr. 28, 2010.

(51) Int. Cl. G07F 17/32

(52) U.S. Cl. CPC G07F 17/3274; G07F 17/32

(57) ABSTRACT

A gaming apparatus, method and system enables communication between members of a social group using machines belonging to the system. Members of a social group are thereby enable to share benefits from members' participation or winnings, by altering operation of gaming machines in use by member of the social group. A license to a progressively increasing portion of an audio-video work may be awarded in response to continuing game play by one or more members of the social group.

### CROSS-REFERENCE TO RELATED APPLICATION

This application claims priority to and is a continuation of U.S. patent application Ser. No. 13/096,833, filed Apr. 28, 2011, which claims priority to, pursuant to 35 U.S.C. §119(e), U.S. Provisional Application No. 61/329,062, filed Apr. 28, 2010, and to U.S. Provisional Application No. 61/351,202, filed Jun. 3, 2010, which applications are specifically incorporated herein, in their entirety, by reference.

### BACKGROUND

### 1. Field

The present disclosure relates to computerized gaming, and more particularly to gaming incorporating social group features.

### 2. Description of Related Art

Slot machine, video poker, and certain other machine gaming devices have been used in casinos since the “Liberty Bell” slot machine was invented by Charles Augustus Fey in the late 1890s. Electromechanical elements were introduced in the 1960s. As computers became ubiquitous elements within many previously mechanical devices in the 1990s, slot machines and other machine gaming devices were developed wherein the gaming outcome was determined by a computer, and the computer controlled the display of the results to the player. Because differing machines have similar pay tables and odds, it is important to differentiate between machines by making the display of the gaming results amusing to the player.

Although this disclosure uses the term “slot machine”, it should be understood that the term is intended to include gaming devices of the type traditionally found on the casino floor, such as Keno machines, blackjack machines, and draw poker machines. Where indicated by the context, the term may also include mechanical or computerized versions of other gaming mechanisms and table games.

Themed gaming devices were a part even of the original “Liberty Bell” slot machine, which displayed the patriotic symbol of the liberty bell. As computer technology evolved, so too did integration of thematic elements into slot play. Today, many slot machines are themed around famous singers, actors, television shows and films. “I Dream of Genie”, Elvis, “The Munsters”, “Wheel of Fortune”, “Star Trek” and “Austin Powers” are all examples of strong brands that have been as the basis for thematic gaming devices.

For the purposes of this disclosure, we will utilize as examples the “Star Trek” game released in 2008 by WMS Industries under license from CBS Studios as well as the “Elvis Presley” slot machine produced by IGT.

Both the Star Trek game and the Elvis game integrate elements from their respective brands into the game play. In the Star Trek game, as part of bonus rounds or in response to other events in the game, video clips from Star Trek episodes are shown, and the player may choose to gamble within variants of the game themed around a particular episode. In the Elvis machine, the live concert footage of various songs is utilized as a thematic element of bonus rounds. The Star Trek machine also utilizes episodic gaming technology, whereby a player is able to make progress through the game, unlocking additional features, and may resume play without losing their achievements at a later time (utilizing a printed ticket containing a record of the progress or a user name). However, the benefits of these achievements are limited to alterations in the game play (for example, the ability to play a game themed based on the “Trouble with Tribbles” episode may be unlocked after winning a certain amount of points within the bonus rounds). Existing technology allows a trivial amount of customization of progress through the game by allowing players to choose which episodes or themes to unlock. However, such customization is not free-form, and ultimately a player who plays the game until sufficient points have been earned will have access to a non-customized machine only, in that all players reaching the “end” of the points-gathering process will have unlocked all of the elements and be playing identical machines.

Progressive jackpots allow players to engage in a group gaming scenario similar to pari-mutuel gambling. In this scenario, as each player actuates a gambling event, a portion of the money goes to a “progressive” jackpot. The jackpot grows until it hits a maximum size or is won. There are also gaming software programs that allow interactive online games, such as poker, where multiple players simultaneously gamble at the same virtual table.

Casino customer loyalty programs are as old as casinos themselves. From the earliest days, “high rollers” were treated to various perks, such as complementary rooms. These loyalty programs evolved over time, and now commonly utilize cards with a computer-readable magnetic strip that may be inserted into a slot machine. The slot machine either records the activity to the card itself, or sends data about the activity to a centralized computer network to accrue rewards based upon the amount of money bet. The rewards are denominated in points, but functionally are assigned a dollar value that may be redeemed for cash or complimentary services. However, these loyalty programs and related rewards are not tied to the particular game.

### SUMMARY

The present disclosure presents a method, system and apparatus for gaming including social group features for identified players. In an aspect, a method for use may a gaming device may include obtaining a first identifier for a first player operating the gaming device, wherein the gaming device is operated to play one or more games of chance in exchange for a wager amount and a result of the one or more games of chance comprises a prize determined in accordance with a payout table. The method may further include determining a second identifier for a second player that is not operating the gaming device, in response to at least one of (i) a predetermined association between the first identifier and the second identifier, or (ii) input from the player input device. For example, the two players may belong to a defined social group indicated by the first player, or the first player may provide other input indicating the identity of the second player. The method may further include communicating information concerning the one or more games of chance played by the first player to a second gaming device operated by the second player having an address that is determined using the second identifier, to alter gaming operation of the second gaming device. As used herein, “gaming operation” refers to operations related to wagering, such as determining an outcome of a game of chance, determining a prize amount, determining a pay table, or determining a non-monetary outcome such as a bonus round.

The method may include aspects for performing using a second gaming device operated by the second player that is in communication with the gaming device operated by the first player. For example, the method may include altering a game result at the second gaming device, in response to the information concerning the games of chance played by the first player. As used herein, a “game result” includes determining an outcome and prize amount of a game of chance, based on a wager amount.

Other aspects of the method may include altering a minimum wager requirement at the second gaming device, in response to the information concerning the games of chance played by the first player. This may include, for example, determining a current average wager per player for a player group including at least the first and second players and lowering a minimum wager requirement for the second player in response to determining that the current average wager exceeds a threshold.

Further aspects of the method may include altering a pay table at the second device, in response to the information from the first gaming device. This may include, for example, determining whether the second device is qualified for pay table alteration, based on a current average wager per player for a player group including at least the first and second players. For example, if the current average wager meets a threshold value, the pay table alteration may be enabled at the second device. Pay table alteration may include, for example, flattening the pay table to provide a higher frequency of winning results with payouts per win, or in the alternative, reducing the frequency of winning results with higher payouts per win. For example, in a group with a sufficiently high average wager, pay tables may be flattened at machines experiencing a run of losses or relatively low wager amounts, optionally in response to player input at the machines where pay tables are flattened, to encourage member of a social group to continue gambling. Later, in response to some event such as a reduced average wager amount, further user input or expiration of a timer, the pay tables may be un-flattened back to an original form.

Still further aspects of the method may include allocating a portion of a bonus round won at the gaming device for play on the second gaming device. For example, the method may include altering the gaming operation of the second device by triggering operation of a bonus feature in response to the information. For more specific example, if a first player wins some number of bonus spins with a predetermined winning outcome of $100, some portion of the spins, wining outcome, or both may be transferred the second machine. Thus, for particular example, the first player may play 80% of the bonus rounds for 80% of the won amount, while the second player may play 20% of the bonus round, which may be awarded as an apparent result of the second player's next game or indicated as a gratuitous share of rounds from the first player, and receive 20% of the won amount.

Aspects of the above method and similar methods may be embodied in a gaming device comprising a processor, a memory, and a network interface. The memory may hold instructions that, when executed by the processor, cause the gaming device to operate a first set of games of chance in exchange for a wager amount from a first player to obtain one or more prizes determined in accordance with a payout table, and to receive information concerning a second set of games of chance played by a second player operating a second gaming device. The memory may further hold instructions for altering gaming operation of the gaming device for the first set of games, in response to the information. The memory may hold further instructions for performing additional aspects of the method described above.

In a separate aspect, a method for performance by a gaming device may provide access or a license to access copyrighted content for example an audio-visual work in exchange for continuing play at a game device. The audio-visual work is independent of the game, although it may be thematically related; for example, rights to use one or more episodes of the classic television show “Star Trek” may be awarded for game play using a “Star Trek” themed gaming device. The method may include serving a set of games of chance using one or more gaming devices, wherein games of the set are played in exchange for respective wagers from a player. The method may further include tracking a current count of games in the set of games, wherein the set of games is defined as games played by the player using the one or more gaming devices after an initial one of the set of games. The method may include awarding a license to use a progressively increasing portion of an audio-video work that is independent of the set of games, based on the current count.

The method may further include copying an incremental portion of the audio-video work to a storage medium, in response to completing each game in the set of games. For example, the gaming device may copy incremental portions of the audio-video work to a removable memory medium or device connected to or inserted into a port of the gaming device. In an alternative, the method may include copying an awarded portion of the audio-video work to a storage medium, in response to completing the set of games. For example, once the player has indicated the set is completed, the game device may copy all awarded audio-visual content to a memory device connected to the gaming device. In the alternative, or in addition, the method may include copying an awarded portion of the audio-video work to a storage medium, in response to user input. Instead or in addition to copying actual content, the gaming device may transmit an indication of awarded content to another device or entity from which the player may later obtain the content. The other entity may push the awarded content to a client designated by the player, for example to the player's smart phone or set-top box, or make the content available for later download. The method may further include tracking a currently awarded portion of the audio-visual work during play of the set of games, and displaying an indication of the currently awarded portion on a display device of the one or more gaming devices.

Aspects of the above method for providing access to content as an award for game play and similar methods may be embodied in a gaming device comprising a processor, a memory, and a network interface. The memory may hold instructions that, when executed by the processor, cause the gaming device to serve a set of games of chance using one or more gaming devices, wherein games of the set are played in exchange for respective wagers from a player. The memory may further hold instructions for tracking a current count of games in the set of games, wherein the set of games is defined as games played by the player using the one or more gaming devices after an initial one of the set of games. The memory may further hold instructions for awarding a license to use a progressively increasing portion of an audio-video work that is independent of the set of games, based on the current count. The memory may hold further instructions for performing additional aspects of the method for providing access to content as an award for game play, as described above.

Further examples and details of the present technology may be obtained from the following detailed description. The drawings referenced in the detailed description are first described briefly.

### BRIEF DESCRIPTION OF THE DRAWINGS

FIG. 1 is a block diagram showing an example of a gaming device for performing one or more methods described herein.

FIG. 2 is a block diagram showing an example of a networked system of gaming devices and other elements that may be used with or to perform one or more methods described herein.

FIG. 3 is a flow chart showing an example of a method that may be performed using the device and system shown in FIG. 1 or 2, or similar systems and devices.

FIG. 4 is a block diagram showing functional modules of an apparatus for performing aspects of the method shown in FIG. 3.

FIG. 5 is a flow chart showing an example of an alternative method for progressively licensing content in as an award for game play.

### DETAILED DESCRIPTION

It is desirable, therefore, to provide a control method, system and apparatus for gaming that provides features not provided in the prior art. This disclosure relates to improvements to the state of the art for slot machines and similar gaming devices. Among other things, these improvements solve a primary problem for the industry, creating customer loyalty to a particular casino and to a particular game, and driving additional consumers to utilize a particular casino and/or a particular game.

The headings set forth below are merely to aid organization and readability of the disclosure, and do not limit the disclosed examples or concepts.

### Integration of Thematic Game Elements as Rewards for Continued Play:

In order to utilize a thematic element in a slot machine, appropriate licenses to copyrights, trademarks, and other intellectual property rights (for example, a right of publicity) need to be secured. The draw for players is the intellectual property elements (for example, a player may choose the Star Trek machine over another machine because the player likes Star Trek). While the episodic gaming elements draw players to continue to gamble in order to unlock additional thematic elements, the player is ultimately still playing only for the ability to gamble further funds within a variant of the game. Progress toward unlocking a new game theme is useless to retain a player who is becoming tired of losing.

One of the improvements enables a player to integrate progress toward obtaining an intellectual property license within a themed game. Thus, for example, a player who has unlocked the “Trouble with Tribbles” theme on the Star Trek game may then be given a license (either perpetual or a time-limited “rental style” license) by operation of a gaming machine to view the episode on which the theme is based. The license may change in duration, in quality of video (such as high definition vs standard definition), in delivery (for example, on demand play in a hotel room or home vs download vs instantly burned DVD vs shipped or previously burned DVD), in amount of the episode or song included within the license (i.e. first 10 minutes vs full episode), or in copy protection status, and such change may be based on time played, amount played, number of friends referred to play the game, amounts gambled within the thematic element, amounts gambled to achieve the thematic element, outcome of a gamble within the game, or some combination thereof.

In one implementation, portions of the episode (or song, in the case of a music license) are recorded to a memory device or medium, for example a removable memory device such as a USB stick or a writable disc medium, as the player gambles within an unlocked (or openly available) thematic element. An optional progress meter indicates how much of the episode or song has been recorded on the key. A player who has run out of cash but who has already earned 45 minutes of the 50 minute “Trouble with Tribbles” episode may be inclined to further gamble not to win money, but to complete the acquisition of that episode. In another implementation, the player is able to elect to spend the points earned toward unlocking additional game play options instead as a credit toward the intellectual property license. In another implementation, the copy protection utilized requires that the memory device or medium be inserted into the machine within a specified period, meaning that the intellectual property licenses acquired would expire unless the user re-visited one of the themed machines within a specified period. Optionally, the expiration may be temporary, and renewed simply by insertion into the machine, potentially with some gambling limit required, some amount of time before viewing even after the episodes or songs had otherwise expired. In another implementation, identifiers for or descriptions of the licenses or content may be recorded to the casino affinity card, and a copy of the content obtained from the casino affinity card office. In another implementation, the user may be required to utilize some amount of value or points from the casino affinity card in order to perfect their license rights.

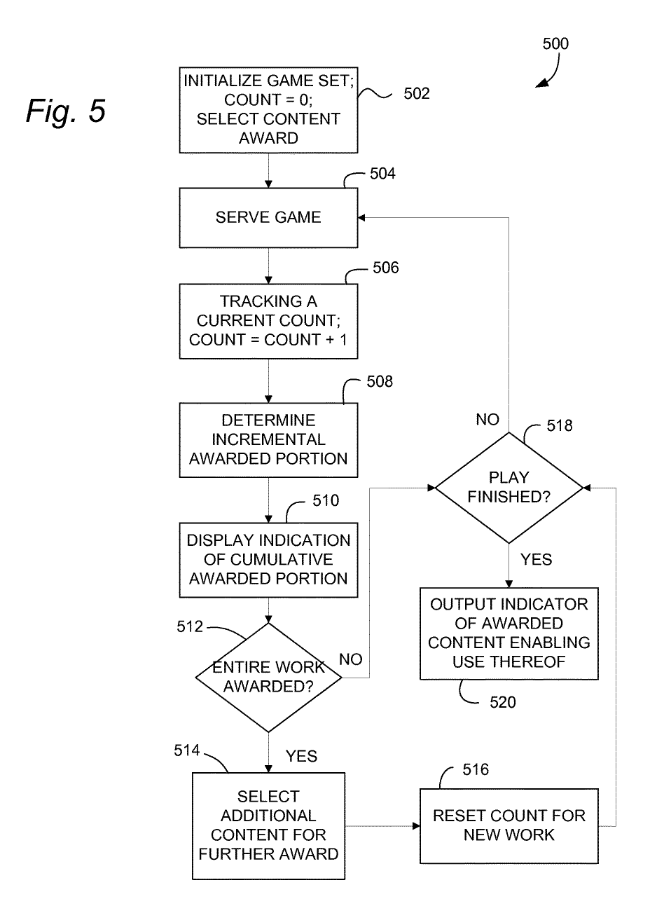

An flow chart exemplifying a method for integrating content elements as a reward for continued game play is described below in connection with FIG. 5.

### Integration of Personalization Elements:

In another aspect, players are enabled to personalize a slot machine using their own images, images pulled from a web server or other networked device, images pulled from a USB stick, images generated by an imaging device integrated into the slot machine, or images selected by a player from a selection of images loaded into the machine. In an aspect, the user may log into a social networking site, such as Facebook, from within the slot machine (whether logging in directly, having their log-in information available on a USB key or stored in their affinity card account, biometrically, or otherwise), or may grant permission within their Facebook account for the casino to obtain images without logging in. The user may have pre-selected the images to be used, or may be presented with the images available within the account (preferably the profile pictures of their friends, presented in order of most frequent to least frequent communication between the friends). It is to be understood that the use of Facebook is as an example only, and this aspect may utilize any social networking mechanism, from email address books to twitter.

While not limited to traditional slot play, it is useful to utilize a traditional slot machine for illustrative purposes. For simplicity, the illustrative slot machine has three possible signs, a blank, a cherry, and a bar. The user might substitute her face for the bar, her husband's face for the cherry, and her mother-in-law's face for the blank. When spinning, if she obtained “husband, mother-in-law, mother-in-law”, she may have actually spun “cherry-blank-blank” and would win the amount associated with that spin.

### Integrated Multiplayer Interaction:

When a player sits at a machine and the machine obtains sufficient information to identify the player (whether by insertion of an affinity card, biometrics, use of a log-in, or otherwise), the machine optionally verifies that the player has given permission to do so (either by checking previous permissions, having “friend” status on facebook, or asking expressly for permission), the machine updates one or more networked services with the status of the player (such as by posting to the player's Facebook status that “Gary is now playing the Star Trek slot machine at the Las Vegas Hilton”).

In an aspect, if a social group user customizes the reels by picking a photograph of a second user in the same social group, the second user may obtain some benefit based upon the player's gaming volume, the player's wins, or the player's wins where the second user's face is either in the pay line, displayed on the slot machine when a win takes place, or is responsible for some portion of the win. “Responsible for some portion of the win” may be defined either as a portion of the overall win or that portion of the win attributable to the presence of that symbol, for example, in a machine with a “wildcard” symbol, a “cherry-wildcard-blank” the cherry is responsible for a cherry-blank-blank portion of the win, while the wildcard is responsible for the amount of the win that exceeds cherry-blank-blank.

In another aspect, the second user may receive a message, such as “Gary is using your photo as one of his slot machine symbols.” In an aspect, that user may be required to log in or otherwise acknowledge that message in order to share in any winnings.

In one implementation, the share of the winnings may be a virtual currency, a play currency, irredeemable points, or points that may be redeemed for intellectual property licenses (particularly for play on themed machines), virtual play on computerized versions of the same (or a different) machine, or for other uses. The share of the winnings may also be limited so as to be usable only as a credit within a gaming establishment, on the same brand or type of machine, or within the same casino. The share of the winnings may also be allocated among these mechanisms.

In an aspect, the friend may be required to acknowledge use of their image prior to its importation and/or display in the game. In another implementation, the friend may be further required to certify that they have the intellectual property rights required for such a use and permit it. In one implementation, the permission may be given with or without a time, amount, place, or other limitation.

In another implementation, a player may opt to give the things of value (i.e. a share of winnings, points, or otherwise) as a gift, optionally choosing what percentage or other share to give. The decision point may be prior to the gaming session, after the gaming session, or changed within the gaming session (even granularly, as in changing with each bet). In an aspect, the location of the user sharing in the proceeds may be utilized to determine which of the options may be legally offered (i.e. in some jurisdictions, it may be required to be a gift given at the conclusion of the gambling session), and the options limited to those legally available.

In another implementation, if two users are simultaneously gambling and choose to use each others' images within their games, the shared payouts may be altered (preferably increased).

In another implementation, when a user logs onto a slot machine, the slot machine may inform the user as to other users affiliated with that user (such as members of a defined social group) who are currently gambling, in an aspect limited to those in the same casino.

In another implementation, if a pair of friends are both gambling and have affiliated their machines (as, for example, by making each others' profile photograph the “bar” sign on their slot machine), there may be interplay between the two slot machines. For example, the first reel of each player's 6-reel machine may become a bonus seventh reel on their counterpart's machine, thereby expanding the chance of wins, such as for example those that require the same symbol to appear in X places on the reels. Similarly, to avoid the requirements that each player wait for the other to spin the reel in order to complete the seventh reel, the seventh reel may constitute the first reel of the prior spin (preferably limited so as each first reel may only be used once). Simply pairing the machines could be used to trigger the presence of an independently determined seventh bonus reel. This may be useful to satisfy legal requirements in jurisdictions where the outcome of one bet is not permitted to influence the outcome of another.

In another implementation, when one of a plurality of affiliated players wins a “bonus round”, all players may be given access to that bonus round. It may involve simply showing the bonus round in a window on the affiliated player's machines, allowing the other players to bet on the outcome of the friend's bonus round, or triggering a bonus round (perhaps at a reduced paytable) for the affiliated machines.

Users within Proximity of Each Other can Satisfy Minimum Bet Requirements by Averaging:

One problem for casinos is that a plurality of affiliated users (such as a husband and wife, or a group of friends) have different budgets for gambling. Taking a husband and wife as an example, the husband may wish to gamble, while the wife does not—or the husband may wish to gamble in a higher denomination than the wife. However, since the couple (which should be understood to also include more than two people in the case of a group of friends) wishes to enjoy a shared experience, the member of the couple with the lower gambling limitation sets the amount bet or causes the couple to leave. As an example, if a row of slot machines has a $0.25 minimum bet and $0.75 maximum bet, the husband wishes to bet $0.75 per spin, but the wife is uncomfortable with more than $0.05 per spin, the couple will move to the nickel machine area to gamble. Even on machines where there is substantial granularity in the amount permitted to be gambled (for example, machines allowing up to 45 rows to be bet on), the husband may desire to bet $11.25 per spin while the wife is uncomfortable with more than $0.15 per spin. Even on machines that allow a choice between 1 and 45 lines and $0.01 and $5.00 per line, the wife is unable to play the same game as the husband, as she is playing substantially fewer lines, and therefore enjoys fewer bonus games and less “action”. Taking the problem further, in the group of friends example, if three friends are out gambling and one of them goes “bust”, the group may feel obligated to retire for the evening rather than exclude the “broke” friend (or loan him money).

To solve each of these issues, a connection between the slot machines, for example via affinity cards, Facebook log-ins, or other method, may be used. The players using the connected machines then become affiliated, and additional flexibility is allowed to the players in gaming denominations. By monitoring the average bet among the group of players, the system permits some machines to offer lower bet amounts. Even if the casino would lose money (by having the machine occupied, by paying for the electric bills and free drinks, etc) by allowing the wife in the foregoing example to bet ⅓ of a penny on each line in order to bet $0.15 total on 45 lines, taking the average bet of $5.70 ($11.25 per spin for the husband and $0.15 per spin for the wife), the casino would make money. Absent the ability to bet below the otherwise extant limit, the husband and wife might both leave. In an aspect, no real money gambling may be required for one or more of the players within an affiliated group so long as the average real money bet exceeds a set limit.

Thus, for example, the “broke” friend may be given 10,000 “play money” credits (preferably indistinguishable from real money credits to passersby so as to avoid any stigmatization), and permitted to play those “play money” credits so long as the other members of his affinity group were continuing to gamble sufficient amounts as to make the overall group's average real money bet exceed a set amount (which amount could vary based on factors such as the number of machines currently in use, time of day, average bet casino-wide, or otherwise). Optionally, the “play money” balance could be purchased for a nominal fee (for example, 100 credits per penny) to keep the game fun (as simply being able to replenish play money credits at will eliminates some of the fun of the game). Optionally, the “play money” balance could actually be a real money bet of sufficiently small value (i.e. 1/100^{th} of a penny per credit) as to drop the amount per bet below the threshold at which the player treats each bet as real money (a gambling analogue to a penny being of such low value that one might not be willing to bend down to pick one up). In an aspect, the play money could be transferred between online gaming and casino gaming. Where legal, the real money balance could be transferred as well.

The casino may set proximity requirements, such as “both gambling anywhere in the casino”, or “gambling on adjacent machines” to trigger the affinity. Optionally, the bet averaging could be weighted by proximity, so that a couple betting on adjacent machines might be averaged in the traditional way, while a couple betting on machines at opposite ends of the casino might be averaged in a way that counts each person's gambling as 90% of their average and their partner's gambling as 10% of their average, so that a husband betting $1.00 per spin and a wife betting $0.10 per spin may yield an average bet for the wife of 10% of the husband's $1.00, or $0.10, plus 90% of the wife's $0.10, or $0.09, for a total average bet for the wife of $0.19.

Users can Change the Pay Table, Optionally Only if they are Proximate to Another Gambler:

The problem of gamblers with partners or groups of friends described in the foregoing section may also be addressed differently using pay table alterations responsive to events at a connected machine. Such alterations may also be useful for keeping a lone gambler suffering bad luck from leaving the machine. A machine may be “qualified” for pay table changes based on the averaging methodology disclosed above. Alternatively, certain pay table changes may be permitted based on the average ongoing (or prior) bets on that single machine, or permitted under any circumstances. In an aspect, the pay table change does not change the overall payout (so a machine paying back 98% would continue to do so). The player may access a button (such as a button titled “change your luck”), a dial, or other input device. When actuated, the player may choose (or have randomly chosen for him in a deprecated implementation) a pay table that meets his needs. In one implementation, this change may be limited based upon that player's recent gaming history. For example, a player who had a statistically unusual series of losses may be offered a pay table that is unavailable to a player who is on a winning streak. The changes to the pay table may change the chances of winning any given spin. Thus, for example, the player on a losing streak might opt for a very flat pay table, where 52% of all spins return nothing and 48% of all spins return double the bet. With such a configuration, a player may be able to occupy a machine far longer than a player with an aggressive pay table where a vast majority of all spins return nothing, but a small number of spins return a massive payout. A primary use for such a pay table option may be to permit one player to continue to play even after his funds have been severely depleted, thus avoiding abandoning his friend who is doing better is thus prefers a pay table with a possible large jackpot.

### Further Examples

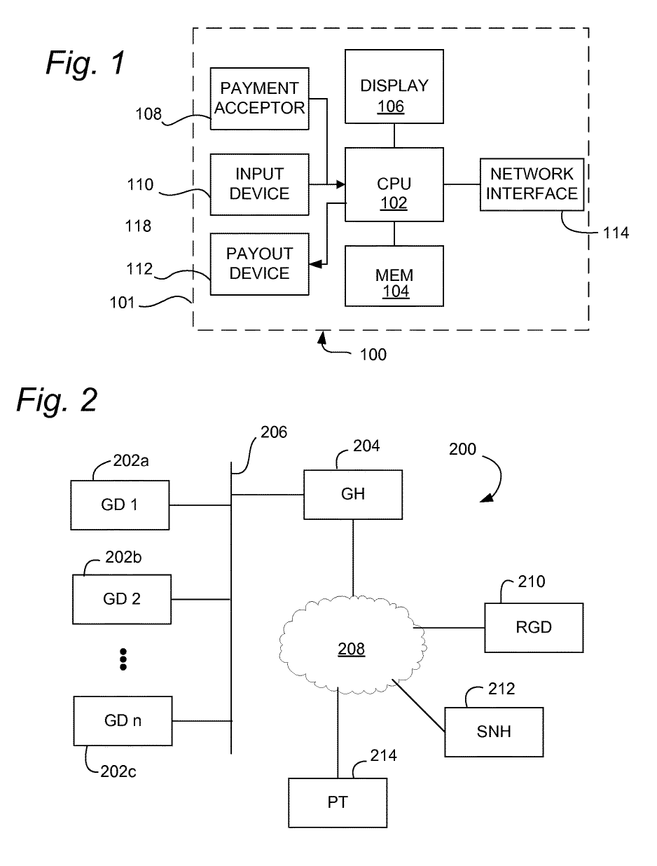

FIG. 1 is a block diagram showing an example of a gaming device 100 such as may be used to perform methods described herein or in systems as described herein. Device 100 may comprise, for example, a casino gaming machine housed in a suitable housing 101. The gaming device may further comprise a processor 102, coupled to a memory 104 holding program instructions, that when executed by the processor, cause the device to perform operations as defined herein. The processor may further be coupled to a display 106 for displaying game progress, game results, game options, and other information to a player using device 100. Other elements that may be included on device 100 may include a payment acceptor device 108 for accepting game wagers, a player input device 110 for enabling a user to select game options and provide other input to the processor 102, and a payout device to payout any winnings from game play. The processor may also be coupled to a network interface 114 in the gaming device, for communicating with like gaming devices or with a system host as described herein.

FIG. 2 shows a system 200 comprising ‘n’ number of gaming devices 202a-202n, each of which may be similar to device 100. Devices 202a-n may be coupled to each other and to a gaming host 204 via a secure local area network (LAN) or equivalent communications network. The gaming host may comprise one or more servers configured to receive and process information from the gaming devices, coordinate and maintain information for players and devices, and provide database services for operation of system 200. The gaming host 204 may be in communication with a remote gaming device 210 and/or a social group host 212, via a wide area network (WAN) 208. The remote gaming device may operate like gaming device 100 or devices 202a-n, albeit communicating with other system components using the WAN 208, e.g., via a secure virtual private network (VPN), instead of a secure LAN. In the alternative, or in addition, the remote gaming device 210 may comprise a game server in which a player can participate in game play via input from an access terminal 214, for example, a personal computer or communication device.

The social group host may operate one or more social networking groups including one or more players playing one or more of devices 202a-n, 210. The SN host 212 may comprise one or more computer servers receiving information from the game host 204 and serving received information to designated accounts. Any member of the one or more players' social groups may access game play information shared by the participating players via the access terminal 214. For example, social group members may be able to tracks a player's progress in game play, and optionally communicate with the player, via the host 212, host 201 and gaming device in use by the player.

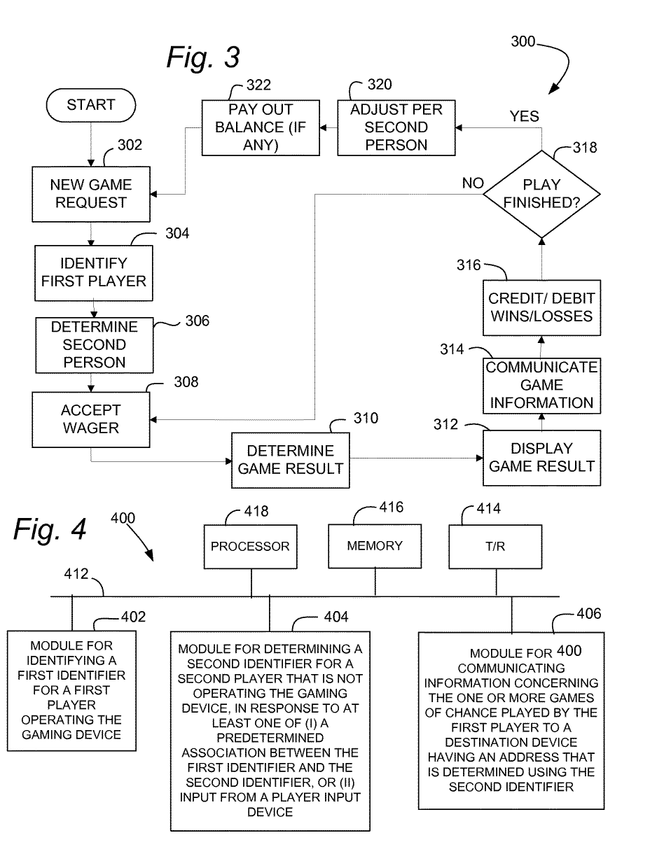

FIG. 3 shows an example of a method 300 that may be performed using a gaming device coupled to a system as described herein. At 302, a first player initiates a new game request at a gaming device. The gaming device may obtain an identifier for the first player 304, for example, by reading information from a magnetic strip or RFID device in a player identification card, or by receiving input information from the player, for example, a user name and password, via a player interface component of the device.

At 306, the gaming device may determine at least one second person, and optionally, multiple second persons, using the player identifier obtained at 304. For example, the gaming device may transmit the identifier together with other information such as its device identifier, to a game host server. The game host server may look up identifiers for the second person or persons using a database, for example, a social network database. For example, second persons may be identified in the social network database as members of a social group to which the first person belongs. In the alternative, or in addition, the second person or persons may be linked to the first person in a database coupled to the game host. In the alternative, or in addition, the gaming device may identify the second persons by input from the player interface device, or obtain identifiers for the second persons encoded in the first player's identification card. The game host server may transmit identifiers for the second person or persons to the gaming device. In the alternative, or in addition, the gaming host may act as a forwarding agent for information from the gaming device to be provided to a social network host or other gaming device for the second player.

At 308, the gaming device may accept a wager in any suitable fashion. For example, the player may deposit money or tokens into the device via a currency acceptor device or token acceptor device, or may authorize use of an amount from an account associated with the first player's identifier, using a player input device, such as a key pad or touchscreen. At 310, the gaming device may determine a game result and display a game result 312. The display may incorporate information from the second player (for example, a second player photo) in the manner described herein.

At 314, the gaming device may communicate game information to the gaming host. For example, the gaming device may communicate information indicating that the first player has chosen an image of (or associated with) the second person to display a game result, has designated the second player as a gaming partner for the game, has designated the second person to share in winnings or bet minimums. In addition, or in the alternative, the gaming device may communicate game identifiers, game device identifiers, and game results to the gaming host or to a second device operated by the second player. At 316, the gaming device may credit or debit game winnings or losses to a running balance for the game session, and display the current balance using the display device. The first machine may adjust the first player's session balance 320 according to the first player's social settings, either after 318 each game or at the end of a gaming session. For example, the first machine may debit any winnings shared with other players, and credit any winnings shared by other players, to the balance amount. After a game session is completed 318, or after each game, the device may pay out any winning balance 322 as known in the art.

Thus, a second gaming device operated by the second player receives transmitted information about the first player's game session at the first gaming device is thereby enabled to modify its operation in response to the information. The second gaming device may alter a game result for the second player, in response to the information. For example, the second gaming device may alter a pay table or odds as indicated herein. In the alternative, or in addition, the second gaming device may alter a minimum wager requirement at the second gaming device, in response to the information. For example, because the first player is wagering an adequate amount at the first gaming device, the second gaming device may temporarily lower its minimum bet amount for the second player. In the alternative, or in addition, the second gaming device may share winnings earned by the first player with the second player, in response to the information. For example, the second device may credit the second player's session balance by a percentage of the first player's winnings. The second gaming device may further display the action it is taking to the second player, and the reason for the action. For example, the second gaming device may output a text message, for example, “John Doe just won $1000 at Social Poker, and is sharing 10% with you!”

The destination device for the first player's game session information may comprise a host for a social networking group that includes the second player. The host may report the first player's progress and results with other members of the first player's designated social group, and take other actions as described elsewhere herein.

With reference to FIG. 4, a gaming apparatus 400 may optionally include a processor module 418 having at least one processor. The processor 418 may be in operative communication with the modules 402-406 via a bus 412 or similar communication coupling. The processor 418 may effect initiation, execution and scheduling of the processes or functions performed by modules 402-408, which may be implemented using software, hardware, firmware, or any suitable combination of the foregoing.

In related aspects, the apparatus 400 may include a transmit/receive module 414, for example, a transceiver or network interface. In further related aspects, the apparatus 400 may optionally include a module for storing information, such as, for example, a memory device/module 416. The computer readable medium or the memory module 416 may be operatively coupled to the other components of the apparatus 400 via the bus 412 or the like. The memory module 416 may be adapted to store computer readable instructions and data for implementing the processes and behavior of the modules 402-406, and subcomponents thereof, or the processor 418, or the methods and operations disclosed herein. The memory module 416 may retain instructions for executing functions associated with the modules 402-406, or other aspects of the methods disclosed herein. While shown as being external to the memory 416, it is to be understood that the modules 402-406 can exist within the memory 416.

The apparatus 400 may further comprise the module 402 configured to receive a first identifier for a first player operating the gaming device 400 to play the one or more games of chance. The gaming device likewise may comprise a module (not shown) to play one or more games of chance in exchange for a wager amount, a result of the one or more games of chance being a prize determined in accordance with a payout table. The module 404 may be configured to determine a second identifier for a second player that is not operating the gaming device 400, in response to at least one of (i) a predetermined association between the first identifier and the second identifier, or (ii) input from a player input device coupled to the gaming device 400, for example, from a key pad, touch screen, or card reader. The module 406 may be configured to communicate information concerning the one or more games of chance played by the first player to a destination device having an address that is determined using the second identifier to alter gaming operation of a second gaming device operated by the second player, via the network interface 414.

In further related aspects, the memory 416 may optionally include executable code for the processor module 418 and/or ones of the modules 402-406 to perform a method that comprises the steps of: (a) obtaining, using a gaming device including a processor, a memory, and a player input device, a first identifier for a first player operating the gaming device, wherein the gaming device is operated to play one or more games of chance in exchange for a wager amount, a result of the one or more games of chance being a prize determined in accordance with a payout table; (b) determining a second identifier for a second player that is not operating the gaming device, in response to at least one of (i) a predetermined association between the first identifier and the second identifier, or (ii) input from the player input device; and (c) communicating information concerning the one or more games of chance played by the first player to a destination device having an address that is determined using the second identifier, to alter gaming operation of the second device. The memory may include further instructions for per performing additional operations and aspects of the methods disclosed herein.

FIG. 5 shows a method 500 that may be performed by a gaming device to award rights to use copyrighted content, for example recorded audio-video works, for game play. The method 500 may include serving 504 one of a set of games of chance using one or more gaming devices, wherein games of the set are played in exchange for respective wagers from a player. The set of games may be defined as games played by the player using the one or more gaming devices starting with an initial one of the set of games. The one game may be an initial game of the set of games, a last game, or an intermediate game. As used herein, “serving” a game includes receiving player inputs include a wager amount, determining an outcome at least partially based on chance, and proving an output signal for displaying the game outcome. Prior to serving the game, the gaming device may initialize 502 a set of games for tracking play, for example in response to a user identifier being provided to the game machine in the form of a login or player card to initiate a game session. This may include setting a counting variable to zero for the set of games. Initialization 502 may further include receiving a user selection of content that the player desires to receive as an award for continued play. To retain user interest, the game device may allow a user to select a desired work from a large library of various works, so that each player may find content of interest. The method 500 may include tracking 506 a current count of games in the set of games, for example by incrementing a counting variable, or tracking a currently awarded portion of the audio-visual work during play of the set of games.

At 508, the gaming device may determine an incremental award portion for the selected audio-video work. For example, the gaming device may accumulate a fixed percentage of the work, for example 5% or 10%, for each game played. For further example, the gaming device may determine a variable percentage based at least in part on a result of the game played at 504. In some embodiments, the awarded portion may be increased in response to a losing result, or a successive string of losing results, so that a player experiencing a string of bad luck in winning a monetary prize would at least be compensated by an increasing share of a desired audio-visual work. Conversely, the share of awarded work may be varied in proportion to the game result. The method 500 may further include displaying 510 an indication of the currently awarded portion on a display device of the one or more gaming devices.

At 512, the gaming device may determine whether or not an entirety (e.g., 100%) of the selected work has been awarded. If all of the work has been awarded, at 514, the gaming device may enable the user to select additional content, e.g., another audio-video work, to be awarded for future play. Then, at 516, the gaming device may reset one or more tracking variables used to keep track of the awarded portion.

At 518, the gaming device may determine whether or not play of the set of games is finished, or has reached a similar demarcation such as a pause or redemption event. This may be determined, for example, by the user providing input such as indicating a “finish” or “redeem awards” via a user interface. In response to determining that play is continuing, the gaming device may resume play at 504. In response to determining that play is finished or the user has requested redemption of awarded rights, the gaming device may provide, at 520, an output indicating the identity and amount of awarded content sufficient to enable use thereof. For example, the method 500 may include awarding a license to use a progressively increasing portion of an audio-video work that is independent of the set of games, based on the current game count. The license may be recorded in some tangible medium for possession by the player and later redemption, or transmitted to another device for recording. The license may be provided with or inherently incorporated in a digital copy of the awarded audio-video work, in any suitable medium, for example, an optical disc medium, magnetic medium or electronic memory device medium.

Various modes of enabling access to awarded content have been discussed in the detailed description above. Such modes may include, for example, copying an incremental portion of the audio-video work to a storage medium, in response to completing each game in the set of games. For example, the gaming device may copy incremental portions of the audio-video work to a removable memory medium or device connected to or inserted into a port of the gaming device. In an alternative, the method may include copying an awarded portion of the audio-video work to a storage medium, in response to completing the set of games. For example, once the player has indicated that game play for a set of games is completed or it is desired to redeem awarded content, the game device may copy all awarded audio-visual content to a memory device connected to the gaming device. In the alternative, or in addition, the game device may copy an awarded portion of the audio-video work to a storage medium, in response to user input. Instead or in addition to copying actual content, the gaming device may transmit an indication of awarded content to another device or entity from which the player may later obtain the content. The other entity may push the awarded content to a client designated by the player, for example to the player's smart phone or set-top box, or make the content available for later download.

The various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

For example, the various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an Application-Specific Integrated Circuit (ASIC). The ASIC may reside in a gaming device or other system element. In the alternative, the processor and the storage medium may reside as discrete components in a gaming device or other system element.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any non-transitory medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM, DVD, Blu-ray or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes but is not limited to compact disc (CD), laser disc, optical disc, digital versatile disc (DVD), magnetic hard disk and Blu-ray disc, wherein disks usually reproduce data magnetically, while discs reproduce data optically with lasers. Combinations of the above should also be included within the scope of computer-readable media.

Processes performed by the gaming machines, or system nodes described herein, or portions thereof, may be coded as machine readable instructions for performance by one or more programmable computers, and recorded on a computer-readable media. The described systems and processes merely exemplify various embodiments of enhanced features for use in an apparatus, method or system for gaming. The present technology is not limited by these examples.

What is claimed is:

1. A method comprising:
obtaining, using a first gaming device, a first identifier for a first player operating the first gaming device, wherein the first gaming device is a first slot machine configured to accept real money and pay out a winning balance and play one or more games of chance in exchange for a real money wager amount per game, and wherein a result of the one or more games of chance comprises a prize determined in accordance with a pay table;
determining a second identifier for a second player operating a second gaming device remote from the first gaming device, wherein the second gaming device is a second slot machine configured to accept real money and pay out a winning balance and play one or more games of chance in exchange for a real money wager per game, and wherein a second result of the one or more games of chance played at the second gaming device comprises a prize determined in accordance with a second pay table;
affiliating the first and second gaming devices based on input from the first and second players; and
communicating information concerning the one or more games of chance played by the first player to the second gaming device operated by the second player having an address that is determined using the second identifier, wherein the information comprises the first reel of the first gaming device, and wherein the first reel of the first gaming device becomes a bonus reel of the second gaming device.

2. The method of claim 1, wherein the input from the first and second players comprises making each other's profile photographs from a social networking site the “bar” sign on their respective slot machines.

3. The method of claim 1, further comprising communicating second information concerning the one or more games of chance played by the second player to the first gaming device operated by the first player having an address determined using the first identifier, wherein the second information comprises the first reel of the second gaming device, and wherein the first reel of the second gaming device becomes a bonus reel of the first gaming device.

4. The method of claim 1, wherein the prize is irredeemable points.

5. The method of claim 1, further comprising altering the second pay table at the second gaming device, in response to the information.

6. The method of claim 5, further comprising altering the pay table, based on an average of ongoing wagers of the first player.

7. The method of claim 5, wherein altering the pay table comprises flattening the pay table.

8. The method of claim 1, wherein the bonus reel of the second gaming device is the first reel of the first gaming device from the prior spin.

9. The method of claim 8, wherein the first reel of each spin of the first gaming device may only be used once as the bonus reel for the second gaming device.

10. An apparatus, comprising:
a first gaming device comprising a processor, a memory, and a network interface, wherein the first gaming device is a slot machine configured to accept monetary value and payout a winning balance and the memory holds instructions that, when executed by the processor, cause the gaming device to perform:
obtaining, using the first gaming device, a first identifier for a first player operating the first gaming device, wherein the first gaming device is operated to play one or more games of chance in exchange for a real money wager amount per game and a result of the one or more games of chance comprises a prize determined in accordance with a pay table;
determining a second identifier for a second player operating a second gaming device remote from the first gaming device, wherein the second gaming device is a second slot machine configured to play one or more games of chance, wherein a second result of the one or more games of chance played at the second gaming device comprises a prize determined in accordance with a second pay table;
affiliating the first and second gaming devices based on input from the first and second players; and
communicating information concerning the one or more games of chance played by the first player to the second gaming device operated by the second player having an address that is determined using the second identifier, wherein the information comprises an independently determined bonus reel.

11. The apparatus of claim 10, wherein the memory holds further instructions for altering a game result at the second gaming device, in response to the information.

12. The apparatus of claim 10, wherein the input from the first and second players comprises making each other's profile photographs from a social networking site the “bar” sign on their respective slot machines.

13. The apparatus of claim 10, further comprising communicating second information concerning the one or more games of chance played by the second player to the first gaming device operated by the first player having an address determined using the first identifier, wherein the second information comprises the first reel of the second gaming device, and wherein the first reel of the second gaming device becomes a bonus reel of the first gaming device.

14. The apparatus of claim 10, wherein the memory holds further instructions for altering the second pay table at the second gaming device, in response to the information.

15. The apparatus of claim 14, wherein the memory holds further instructions for altering the pay table, based on an average of ongoing wagers of the first player.

16. The apparatus of claim 14, wherein the memory holds further instructions for altering the pay table at least in part by flattening the pay table.

17. The apparatus of claim 10, wherein the memory holds further instructions for allocating a portion of a bonus round won at the first gaming device for play on the second gaming device.

18. The apparatus of claim 10, wherein the prize is irredeemable points.
